(19) United States
(12) Patent Application Publication
(10) Pub. No.: US 2013/0151197 A1
(43) Pub. Date: Jun. 13, 2013

(54) AUTOMATED PERFORMANCE MEASUREMENT PROCESSES AND SYSTEMS

(71) Applicant: General Electric Company, Schenectady, NY (US)

(72) Inventors: Johny Vattathara, Park Ridge, NJ (US); Vincent Eppner, Park Ridge, NJ (US)

(73) Assignee: General Electric Company, Schenectady, NY (US)

(21) Appl. No.: 13/683,208

(22) Filed: Nov. 21, 2012

Related U.S. Application Data
(63) Continuation of application No. 61/563,340, filed on Nov. 23, 2011.

(51) Int. Cl. G06F 17/18

(52) U.S. Cl. CPC G06F 17/18
USPC 702/179

(57) ABSTRACT

Certain examples provide methods and systems to monitor performance. An example method includes triggering automated execution of one or more applications on one or more medical servers according to a selected template providing data for application execution. The example method includes monitoring the execution of the one or more applications to collect application execution information. The example method includes generating one or more log files based on the monitoring of the execution. The example method includes invoking a monitoring tool to process the log files and to provide statistical analysis regarding performance. The example method includes creating a report based on the statistical analysis.

### RELATED APPLICATIONS

This patent claims priority to U.S. Provisional Application Ser. No. 61/563,340, entitled “Automated Performance Measurement Processes and Systems,” which was filed on Nov. 23, 2011 and is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Performance statistics can be important in improving performance and marketing a product. However, current systems provide only a disconnected, siloed approach to performance measurement. For example, prior monitoring occurs within a monitored system, which can affect the performance that is being monitored.

### BRIEF SUMMARY

Certain examples provide systems and methods to measure performance, calculate metrics, and facilitate service. Certain examples provide a view of performance statistics information. Certain examples collect system hardware and/or software configuration information and monitor system utilization to measure system (e.g., GE PACS-IW® viewer) performance statistics.

Certain examples provide a method to monitor performance. The example method includes triggering automated execution of one or more applications on one or more medical servers according to a selected template providing data for application execution. The example method includes monitoring the execution of the one or more applications to collect application execution information. The example method includes generating one or more log files based on the monitoring of the execution. The example method includes invoking a monitoring tool to process the log files and to provide statistical analysis regarding performance. The example method includes creating a report based on the statistical analysis.

Certain examples provide a tangible computer-readable storage medium including computer program instructions for execution by a computer, the instructions, which executed, are to implement a method to monitor performance. The example method includes triggering automated execution of one or more applications on one or more medical servers according to a selected template providing data for application execution. The example method includes monitoring the execution of the one or more applications to collect application execution information. The example method includes generating one or more log files based on the monitoring of the execution. The example method includes invoking a monitoring tool to process the log files and to provide statistical analysis regarding performance. The example method includes creating a report based on the statistical analysis.

### BRIEF DESCRIPTION OF SEVERAL VIEWS OF THE DRAWINGS

FIGS. 1-3 illustrate example healthcare or clinical information systems.

FIG. 4 is a block diagram of an example processor system that may be used to implement systems and methods described herein.

FIG. 5 illustrates an example automated performance measurement process and system and associated process/data flow

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain examples provide systems and methods to measure performance, calculate metrics, and facilitate service. Certain examples provide a view of performance statistics information. Certain examples collect system hardware and/or software configuration information and monitor system utilization to measure system (e.g., GE PACS-IW® viewer) performance statistics.

Certain examples help to evaluate impacts on performance caused by feature changes between different product releases. Certain examples help to identify performance bottlenecks for future improvements (e.g., identify an environment that may not have been previously considered but has now been encountered in real life.

Certain examples generate a log file while the viewer is running and process a log file of collected use information to compute and display viewer performance data. In certain examples, a viewer is launched outside the user's system and is instructed to collect a log on user and/or system activity. Certain examples can open one or more log files, display configuration information, display utilization information, plot thread activities of the viewer, display overall viewer performance statistics, compare viewer statistics from different studies, export comparison results (compare good logs to bad logs to see the difference), etc.

Certain examples provide a performance process and system that can incorporate logic into automated scripts for statistical confidence. Certain examples help ensure that data points are consistent and reliable when performance testing. Often, there are significant variations/spikes in data points and it is desirable to make sure that a data set is reliable.

Certain examples can be embedded in an automation script (e.g., in an HP Quick Test Professional (QTP) script). Certain examples gather performance data, restart servers and collect information multiple times. At some point, another script triggers and scans through the data points, for example. Certain examples take variance, mean, etc., and make sure the result actually meets the standard deviation (upper limit, lower limit). If any of the readings are not within the limits, then the process runs the performance test until a certain confidence level or score (e.g., 75% confidence, 95% confidence, etc.) is reached.

Certain examples are self-adjusting, self-correcting until a reliable reading is obtained. In certain examples radicals (e.g., bad studies) are discarded until confidence is obtained.

Rather than a disconnected, siloed effort, an integrated, automated, embedded intelligence is provided. Certain examples provide a process, a template to feed data points for performance analysis, automated graph creation, etc. Statistical automation can feed into this process, for example. Certain examples reject noise from true values for a more accurate and reliable analysis.

Certain examples are useful customers, equipment manufacturers, and partners. Partners can validate their products based on the disclosed process. Certain examples provide a template for feeding data into the performance process, and a report is then generated.

Certain examples provide one or more of the following: a performance process including an identification of noise from useful data; system automation (e.g., upper level metrics, control based on statistic values to do automation, etc.); determination of appropriate sample size; a template to combine all of these things to define trends, metrics, values and generate a report; etc.

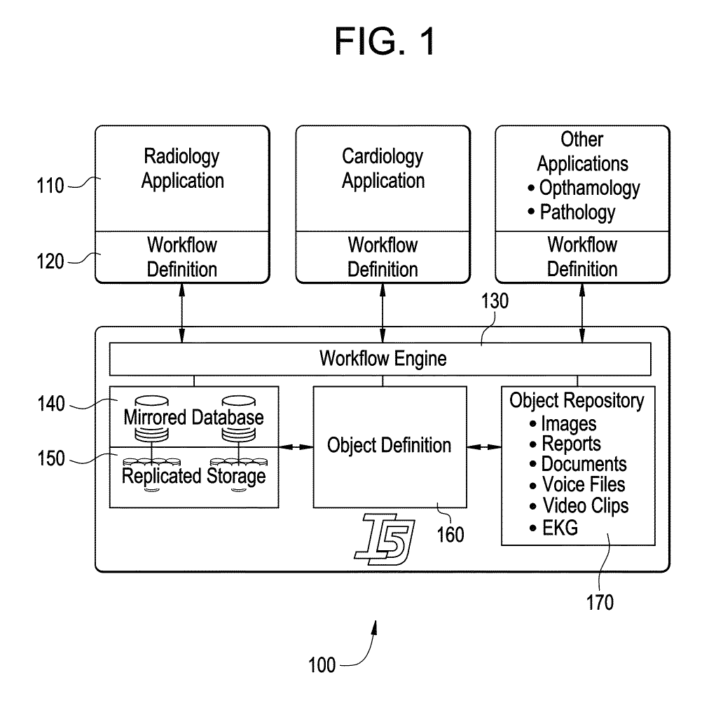

Certain examples can be implemented and/or used in conjunction with an information system for a healthcare enterprise including a PACS system for radiology and/or other subspecialty system as demonstrated by the business and application diagram in FIG. 1. The system 100 of FIG. 1 includes a clinical application 110, such as a radiology, cardiology, ophthalmology, pathology, and/or application. The system 100 also includes a workflow definition 120 for each application 110. The workflow definitions 120 communicate with a workflow engine 130. The workflow engine 130 is in communication with a mirrored database 140, object definitions 60, and an object repository 170. The mirrored database 140 is in communication with a replicated storage 150. The object repository 170 includes data such as images, reports, documents, voice files, video clips, EKG information, etc.

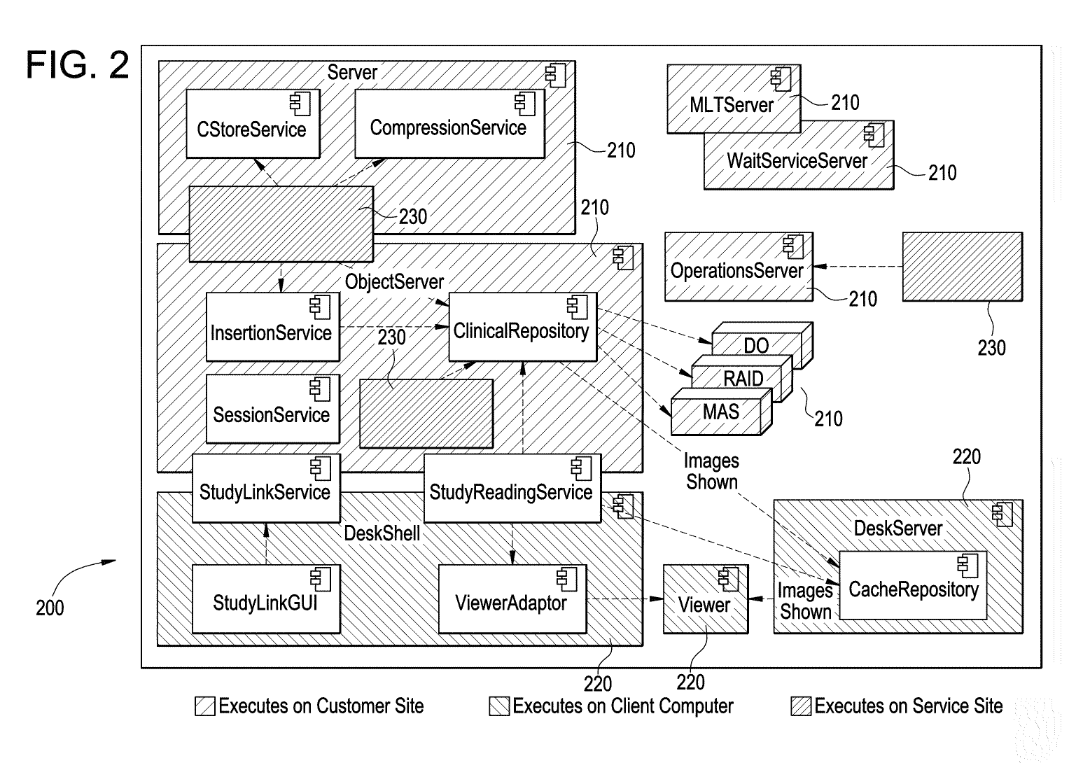

An embodiment of an information system that delivers application and business goals is presented in FIG. 2. The information system 200 of FIG. 2 demonstrates services divided among a service site 230, a customer site 210, and a client computer 220. For example, a Dicom Server, HL7 Server, Web Services Server, Operations Server, database and other storage, an Object Server, and a Clinical Repository execute on a customer site 210. A Desk Shell, a Viewer, and a Desk Server execute on a client computer 220. A Dicom Controller, Compiler, and the like execute on a service site 230. Thus, operational and data workflow may be divided, and only a small display workload is placed on the client computer 220, for example.

Certain embodiments provide an architecture and framework for a variety of clinical applications. The framework can include front-end components including but not limited to a Graphical User Interface (“GUI”) and can be a thin client and/or thick client system to varying degree, which some or all applications and processing running on a client workstation, on a server, and/or running partially on a client workstation and partially on a server, for example.

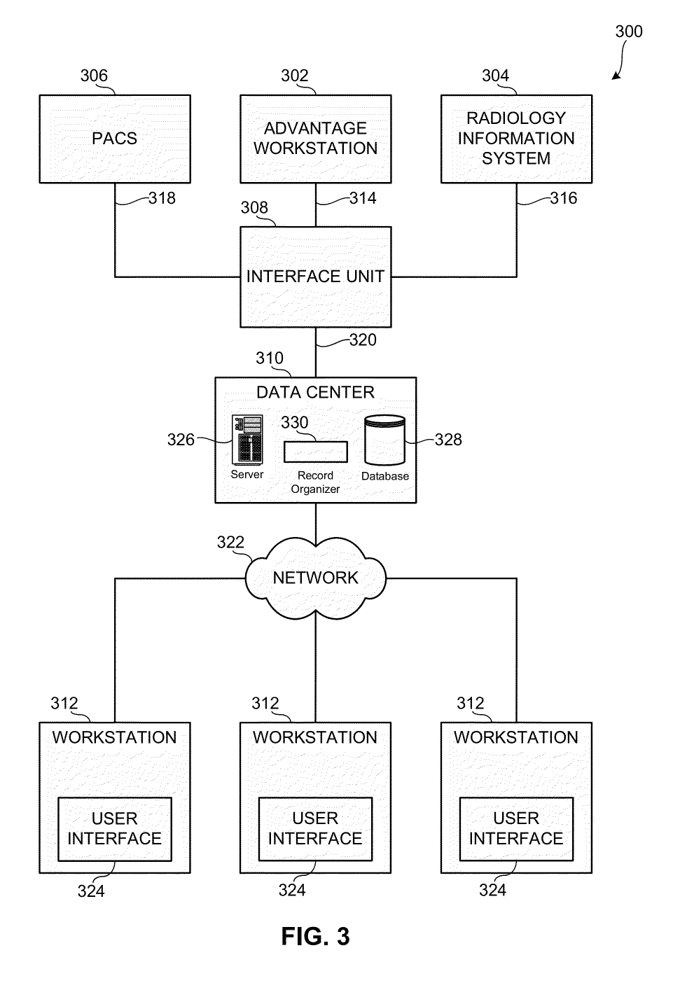

FIG. 3 shows a block diagram of an example clinical information system 300 capable of implementing the example methods and systems described herein. The example clinical information system 300 includes a clinical application or advantage workstation (“AW”) 302, a radiology information system (“RIS”) 304, a picture archiving and communication system (“PACS”) 306, an interface unit 308, a data center 310, and a plurality of workstations 312. In the illustrated example, the AW 302, the RIS 304, and the PACS 306 are housed in a healthcare facility and locally archived. However, in other implementations, the AW 302, the RIS 304, and/or the PACS 306 may be housed one or more other suitable locations. In certain implementations, one or more of the PACS 306, RIS 304, AW 302, etc., can be implemented remotely via a thin client and/or downloadable software solution. Furthermore, one or more components of the clinical information system 300 may be combined and/or implemented together. For example, the RIS 304 and/or the PACS 306 may be integrated with the AW 302; the PACS 306 may be integrated with the RIS 304; and/or the three example information systems 302, 304, and/or 306 may be integrated together. In other example implementations, the clinical information system 300 includes a subset of the illustrated information systems 302, 304, and/or 306. For example, the clinical information system 300 may include only one or two of the AW 302, the RIS 304, and/or the PACS 306. Preferably, information (e.g., image data, image analysis, processing, scheduling, test results, observations, diagnosis, etc.) is entered into the AW 302, the RIS 304, and/or the PACS 306 by healthcare practitioners (e.g., radiologists, physicians, and/or technicians) before and/or after patient examination.

The AW 302 provides post-processing and synergized imaging techniques, across computed tomography (CT), magnetic resonance imaging (MRI), positron emission tomography (PET), single-photon emission computed tomography (SPECT), interventional radiology, etc. The AW 302 can provide 2D, 3D, and/or 4D post-processing workstation as well as facilitate remote review and sharing of images in real time. The RIS 304 stores information such as, for example, radiology reports, messages, warnings, alerts, patient scheduling information, patient demographic data, patient tracking information, and/or physician and patient status monitors. Additionally, the RIS 304 enables exam order entry (e.g., ordering an x-ray of a patient) and image and film tracking (e.g., tracking identities of one or more people that have checked out a film). In some examples, information in the RIS 304 is formatted according to the HL-7 (Health Level Seven) clinical communication protocol.

The PACS 306 stores medical images (e.g., x-rays, scans, three-dimensional renderings, etc.) as, for example, digital images in a database or registry. In some examples, the medical images are stored in the PACS 306 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 306 for storage. In some examples, the PACS 306 may also include a display device and/or viewing workstation to enable a healthcare practitioner to communicate with the PACS 306.

The interface unit 308 includes a hospital information system interface connection 314, a radiology information system interface connection 316, a PACS interface connection 318, and a data center interface connection 320. The interface unit 308 facilities communication among the AW 302, the RIS 304, the PACS 306, and/or the data center 310. The interface connections 314, 316, 318, and 320 may be implemented by, for example, a Wide Area Network (“WAN”) such as a private network or the Internet. Accordingly, the interface unit 308 includes one or more communication components such as, for example, an Ethernet device, an asynchronous transfer mode (“ATM”) device, an 802.11 device, a DSL modem, a cable modem, a cellular modem, etc. In turn, the data center 310 communicates with the plurality of workstations 312, via a network 322, implemented at a plurality of locations (e.g., a hospital, clinic, doctor's office, other medical office, or terminal, etc.). The network 322 is implemented by, for example, the Internet, an intranet, a private network, a wired or wireless Local Area Network, and/or a wired or wireless Wide Area Network. In some examples, the interface unit 308 also includes a broker (e.g., a Mitra Imaging's PACS Broker) to allow medical information and medical images to be transmitted together and stored together.

In operation, the interface unit 308 receives images, medical reports, administrative information, and/or other clinical information from the information systems 302, 304, 306 via the interface connections 314, 316, 318. If necessary (e.g., when different formats of the received information are incompatible), the interface unit 308 translates or reformats (e.g., into Structured Query Language (“SQL”) or standard text) the medical information, such as medical reports, to be properly stored at the data center 310. Preferably, the reformatted medical information may be transmitted using a transmission protocol to enable different medical information to share common identification elements, such as a patient name or social security number. Next, the interface unit 308 transmits the medical information to the data center 310 via the data center interface connection 320. Finally, medical information is stored in the data center 310 in, for example, the DICOM format, which enables medical images and corresponding medical information to be transmitted and stored together.

The medical information is later viewable and easily retrievable at one or more of the workstations 312 (e.g., by their common identification element, such as a patient name or record number). The workstations 312 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 312 receive commands and/or other input from a user via, for example, a keyboard, mouse, track ball, microphone, etc. As shown in FIG. 3, the workstations 312 are connected to the network 322 and, thus, can communicate with each other, the data center 310, and/or any other device coupled to the network 322. The workstations 312 are capable of implementing a user interface 324 to enable a healthcare practitioner to interact with the clinical information system 300. For example, in response to a request from a physician, the user interface 324 presents a patient medical history. Additionally, the user interface 324 includes one or more options related to the example methods and apparatus described herein to organize such a medical history using classification and severity parameters.

The example data center 310 of FIG. 3 is an archive to store information such as, for example, images, data, medical reports, and/or, more generally, patient medical records. In addition, the data center 310 may also serve as a central conduit to information located at other sources such as, for example, local archives, hospital information systems/radiology information systems (e.g., the HIS 302 and/or the RIS 304), or medical imaging/storage systems (e.g., the PACS 306 and/or connected imaging modalities). That is, the data center 310 may store links or indicators (e.g., identification numbers, patient names, or record numbers) to information. In the illustrated example, the data center 310 is managed by an application server provider (“ASP”) and is located in a centralized location that may be accessed by a plurality of systems and facilities (e.g., hospitals, clinics, doctor's offices, other medical offices, and/or terminals). In some examples, the data center 310 may be spatially distant from the AW 302, the RIS 304, and/or the PACS 306 (e.g., at General Electric® headquarters). In certain examples, the AW 302 can be integrated with one or more of the PACS 306, RIS 304, etc., via a messaging framework and viewer.

The example data center 310 of FIG. 3 includes a server 326, a database 328, and a record organizer 330. The server 326 receives, processes, and conveys information to and from the components of the clinical information system 300. The database 328 stores the medical information described herein and provides access thereto. The example record organizer 330 of FIG. 3 manages patient medical histories, for example. The record organizer 330 can also assist in procedure scheduling, for example.

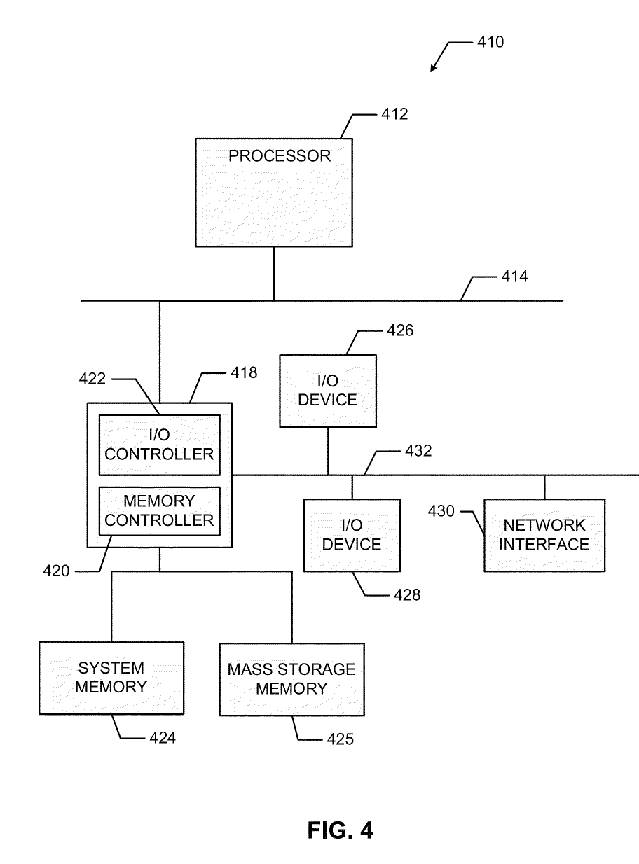

FIG. 4 is a block diagram of an example processor system 410 that may be used to implement systems and methods described herein. As shown in FIG. 4, the processor system 410 includes a processor 412 that is coupled to an interconnection bus 414. The processor 412 may be any suitable processor, processing unit, or microprocessor, for example. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (SRAM), dynamic random access memory (DRAM), flash memory, read-only memory (ROM), etc. The mass storage memory 425 may include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

Certain examples provides an integrated, automated, intelligence embedded in the script, rather than disconnected siloed effort. Statistical automation can be feed into a performance process using a template to provide data points, self-adjustment of data points kept and used for analysis, and automated graphing of results. Certain examples provide performance monitoring and analysis for customers and tools for partners. Noise is identified and separated from usable data, and a template is formed to combine the data for analysis including trends, metrics, values, and report generation.

Certain example help to make sure that data points are consistent and reliable when performance testing is undertaken. There are often significant variations or spikes in collected data points, and vendors want to make sure that the data is reliable for accurate performance testing and measurement.

Certain examples take into account variations in data or other outlier data points to provide a consistent and reliable data set for performance measurement. Certain examples collect system hardware and software configuration information and monitors system utilization to provide performance statistics. Performance impacts can be evaluated and performance bottlenecks can be identified. Rather than a siloed or fragmented effort, example systems and methods provide an integrated, automated, intelligence embedded in a script being executed. For other users/partners, a template can be generated to dictate how data is put into the performance process, and a report is then automatically generated.

Certain examples incorporate logic into automated scripts for statistical confidence processing and analysis. Certain examples can be provided with a system or other product to provide real time (or substantially real time) or periodic feedback on that system's performance.

Certain examples provide a process and utilities to provide statistical confidence on various datapoints used to determine product quality and software performance. A confidence level is achieved by deriving the sample size, performing statistical calculations and automating the process using functional automation tool(s).

In certain examples, a process identifies appropriate sample size, based on datapoint characteristics. The example process helps ensure datapoints are consistent and reliable during performance testing or the measurement process. The example process identifies variations/spikes in data points to help ensure an analysis is reliable.

Certain examples are self-adjusting, self-correcting to obtain reliable readings as a result of analysis. Radicals (e.g., bad datapoints, reject noise from true values, etc.) are discarded until confidence is obtained (e.g., a certain confidence level, threshold, score, etc. is met).

Certain examples provide integrated intelligence embedded in an automated testing and/or processing script, rather than traditional way of disconnected and siloed efforts for collecting datapoints, calculation of statistical parameters, determination of outliers and re-execution or retake. An example automated script performs statistical calculation of standard deviation, mean, Sigma, etc., to determine datapoint integrity. This automated process also creates a report and graph after execution by feeding datapoints to a report template, for example. This example process utilizes and leverages performance/process statistics monitoring tools, etc.

In certain examples, an embedded automation script goes through an application (e.g., GE PACS-IW®) and gathers performance data and collects information multiple times as determined by sample size. At an appropriate collection level, the script triggers and scans through the collected data points. The script performs statistical calculations and makes sure the collected data actually meets the input criteria, and, if any of the readings are not in the appropriate limits, then the process repeats the performance test until a certain confidence (e.g., 95%) is achieved.

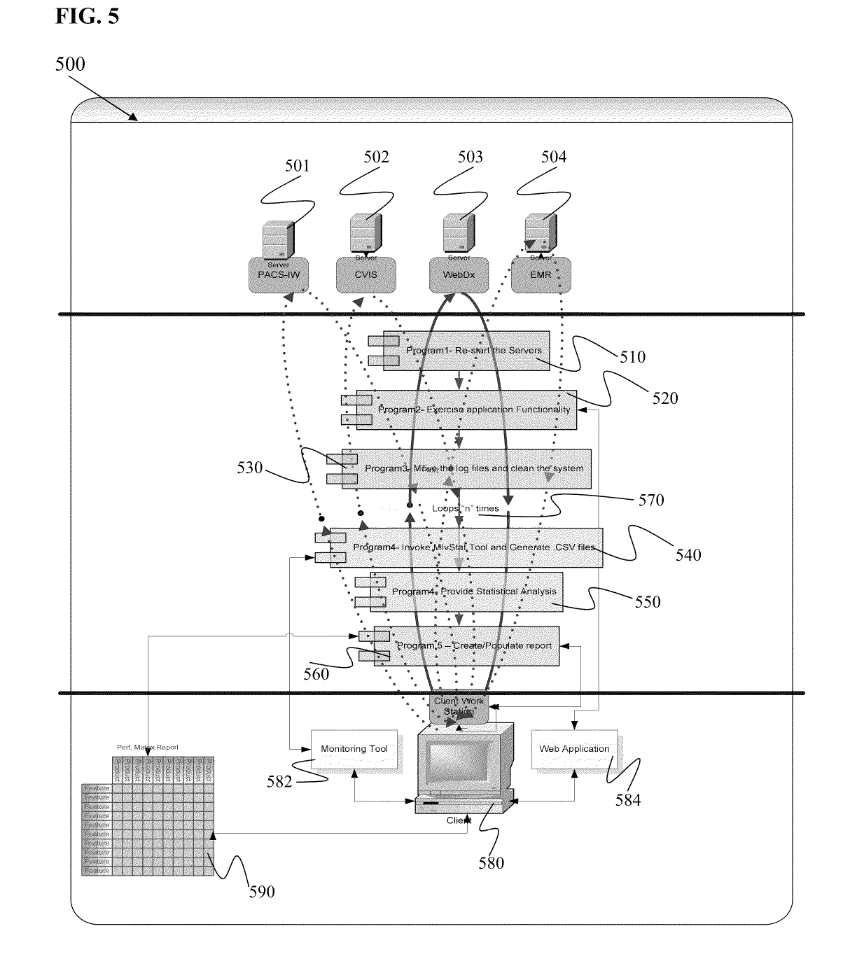

FIG. 5 illustrates an example automated performance measurement process and system and associated process/data flow 500. The example system 500 includes a plurality of clinical systems 501-504 (e.g., PACS, CVIS, EMR, etc.) a client workstation 580, a Web-accessible interface 584, and a performance monitoring tool 582. As shown in FIG. 5, at 510, a first process restarts the server(s) 501-504 involved in the monitoring. At 520, a second process exercises monitored application functionality. At 530, a third process moves log file(s) and cleans the system. At 540, a fourth process invokes the monitoring tool 582 and generates log file(s). At 550, a fifth process provides statistical analysis. At 560, a sixth process creates/populates a report 590. At 570, the process can loop “n” times to allow repeated measurement and analysis to occur. The example processes 510-560 can be expanded or combined according to a variety of implementations in hardware, software, firmware, etc. A report 590, such as a performance matrix report, can be generated.

In more detail, the system and associated method 500 can be used to automate a process to determine product quality and performance with a high statistical confidence. Using the system and method 500, data points (including spikes present in a collected series of data points) can be validated for consistency and reliability when performance testing.

At 510, an automation script begins a gathering of performance data by restarting one or more servers 501-504 involved in the performance monitoring process. By restarting the monitored server(s) 501-504, a new or “fresh” data set can be collected (e.g., without effect from prior activity, etc.).

At 520, application functionality is exercised. For example, one or more monitored applications at one or more monitored systems 501-504 are executed by an automated program or script to monitor or record data, events, and performance information (e.g., processor performance, memory performance, communication performance, application execution, etc.). In certain examples, one or more templates are used to provide one or more inputs, data points, etc., to the monitored application(s). In certain examples, statistical automation provides input for automated execution and monitoring to produce output for evaluation or comparison, for example. Application execution and/or other monitoring information (e.g., inputs, outputs, hardware and/or software configuration information, can be captured in one or more log files and/or other data capture, for example.

In certain examples, application execution is determined based at least in part on an identified sample size. An appropriate sample size can be determined based on one or more datapoint characteristics, for example.

At 530, log file(s) and/or other output(s) generated through the application execution are moved to a location for analysis, and the system is cleaned following the application execution and monitoring. For example, by relocated generated log files and cleaning the system (e.g., restoring the system to a pre-execution state), the system is prepared for a re-start and/or other execution.

At 540, the monitoring tool 584 is invoked. The monitoring tool 584 collects system 501-504 hardware and/or software configuration information and monitors system 501-504 utilization. The monitoring tool 584 measures performance statistics based on the above execution and monitoring, for example. The monitoring tool 584 can be used to evaluate an impact on performance cause by a feature change, a change in input data, etc. The monitoring tool 584 can identify performance bottlenecks for future improvements, for example. Using the log file(s) generated while one or more applications are running and/or one or more systems are executing, the tool 584 processes and displays performance data. The tool 584 can generate log and/or other output files based on monitoring activity and associated processing.

At 550, statistical analysis is provided. For example, the monitoring tool 584 can provide statistical analysis based on captured execution and/or other performance information. For example, the monitoring tool 584 can open one or more log files, display configuration information, display utilization information, plot thread activities of a monitored application, display overall application performance statistics, compare performance statistics from different studies, and export comparison results (e.g., compare good logs to bad logs to see the difference), etc. The tool 584 can be used to verify a claim of application or system execution performance, for example. Various statistics such as mean, median, standard deviation, etc., can be calculated. For example, an image viewer application can be executed and monitored to capture, analyze, and report on metrics as image data is transferred, analyzed, annotated, reported, etc.

At 560, a report 590 is created and/or otherwise populated based on the analysis. A performance matrix report organized by product and feature, for example, can be generated. The report 590 can be generated as a result of a process 510-570 organized and embedded into an automated script rather than as a disconnected, siloed effort, for example. The report can be updated as the process loops 570, for example.

At 570, the process can be repeated one or more times to help make sure that collected data points are consistent and reliable when performance testing. For example, if significant variations/spikes in collected data points are observed, the system 500 wants to make sure the variation/spike is reliable. By looping, the process and system 500 can be self-adjusting and self-correcting until reliable reading(s) are produced. In certain examples, radicals (e.g., bad studies) can be discarded until a measure of confidence is obtained in the results. In certain examples, the monitoring tool 584 determines whether the process repeats based on a confidence measure calculated for the monitored output and/or associated analysis. Thus, the tool 584 can be used with an automated script to collect datapoints, calculate statistical parameters, determine outliers, and trigger re-execution. Statistical calculation of standard deviation, mean and Sigma can be used to determine datapoint integrity. As a result, a report and/or graph 590 can be created by feeding datapoints to a report template, for example.

In certain examples, using an automated script, performance data is gathered, and information can be collected multiple times as determined by sample size. At an appropriate collection level, the script triggers and scans through the collected data points. The script performs statistical calculations and helps ensure the calculations meet input criteria. If any of the readings are not in the appropriate limits, then the process repeats the performance test until a threshold (e.g., 75%, 95%, etc.) confidence is achieved.

In certain examples, a template specifies how and/or which data is provided into the performance process. A report is then generated. Noise can be separated from useful data, for example. In certain examples, upper level metrics can be generated through system monitoring, and control if the performance process can be automatically facilitated based on calculated performance statistic values. A template can help to specify a sample size and combine factors, parameters, and measured data to define trends, metrics, values, etc., and to generate a report. In certain examples, the performance monitoring systems and methods can be implemented in a viewer to be launch viewer outside of the monitored system(s).

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the claimed scope.

1. A computer-implemented method to monitor performance, the method comprising:
triggering automated execution of one or more applications on one or more medical servers according to a selected template providing data for application execution;
monitoring the execution of the one or more applications to collect application execution information;
generating one or more log files based on the monitoring of the execution;
invoking a monitoring tool to process the log files and to provide statistical analysis regarding performance; and
creating a report based on the statistical analysis.

2. The method of claim 1, wherein the method is facilitated via a single automated script.

3. The method of claim 1, wherein the report comprises a performance matrix report organized by product and feature.

4. The method of claim 1, wherein the one or more medical servers comprise one or more of a picture archiving and communication system, a cardiovascular information system, and an electronic medical record system.

5. The method of claim 1, further comprising restarting the one or more medical servers prior to triggering execution of the one or more applications.

6. The method of claim 5, further comprising repeating the process one or more times beginning with restarting and updating the report after each repetition.

7. The method of claim 5, wherein the process is repeated until a target confidence level is reached.

8. The method of claim 7, wherein the confidence level is generated based on a variance in collected performance statistics.

9. The method of claim 8, wherein variation or spike in collected application execution information is evaluated to reject data noise from collected information and performance statistics to determine the confidence level.

10. The method of claim 1, wherein the one or more applications includes an image viewer and wherein statistical analysis of performance includes comparison of image viewer statistics across different image studies.

11. A tangible computer-readable storage medium including computer program instructions for execution by a computer, the instructions, which executed, are to implement a method to monitor performance, the method comprising:
triggering automated execution of one or more applications on one or more medical servers according to a selected template providing data for application execution;
monitoring the execution of the one or more applications to collect application execution information;
generating one or more log files based on the monitoring of the execution;
invoking a monitoring tool to process the log files and to provide statistical analysis regarding performance; and
creating a report based on the statistical analysis.

12. The computer-readable storage medium of claim 11, wherein the method is facilitated via a single automated script.

13. The computer-readable storage medium of claim 11, wherein the report comprises a performance matrix report organized by product and feature.

14. The computer-readable storage medium of claim 11, wherein the one or more medical servers comprise one or more of a picture archiving and communication system, a cardiovascular information system, and an electronic medical record system.

15. The computer-readable storage medium of claim 11, wherein the method further comprises restarting the one or more medical servers prior to triggering execution of the one or more applications.

16. The computer-readable storage medium of claim 15, wherein the method further comprises repeating the process one or more times beginning with restarting and updating the report after each repetition.

17. The computer-readable storage medium of claim 15, wherein the process is repeated until a target confidence level is reached.

18. The computer-readable storage medium of claim 17, wherein the confidence level is generated based on a variance in collected performance statistics.

19. The computer-readable storage medium of claim 18, wherein variation or spike in collected application execution information is evaluated to reject data noise from collected information and performance statistics to determine the confidence level.

20. The computer-readable storage medium of claim 11, wherein the one or more applications includes an image viewer and wherein statistical analysis of performance includes comparison of image viewer statistics across different image studies.
